(19) United States
(12) Patent Application Publication
(10) Pub. No.: US 2002/0092383 A1
(43) Pub. Date: Jul. 18, 2002

(54) Tool for tightening a bolt

(76) Inventor: Fumiyoshi Nezigane, Shizuoka-ken (JP)

Correspondence Address: HARRISON & EGBERT, 412 MAIN STREET, 7TH FLOOR, HOUSTON, TX, 77002, US

(21) Appl. No.: 09/760,516

(22) Filed: Jan. 16, 2001

(51) Int. Cl. B25B 13/06

(52) U.S. Cl. 81/121.1

(57) ABSTRACT

A tool for tightening a bolt in a very narrow place. A substantially circular plate 1 has a thickness approximately the same as the thickness of a hexagonal bolt head 3. The substantially circular plate is provided in a center thereof with a socket 5, which has a hexagonal shape corresponding to said hexagonal bolt head. The socket has a stopper portion 7 adapted to contact a top surface of the bolt head so as to prevent the bolt head from passing through the socket. The substantially circular plate is provided on a periphery thereof with engagement projections 9. The substantially circular plate is easily turned by pushing one of the engagement projections by means of a tip of a screwdriver.

### BACKGROUND OF THE INVENTION

1. Field of the Invention

The present invention relates to a tool for tightening a bolt. More particularly, the invention relates to a tool for tightening a bolt in a place that is too narrow to use a wrench, for example, within an engine compartment of an automotive vehicle.

2. Description of the Prior Art

A conventional method for tightening a bolt in a very narrow place, for example, within an engine compartment of an automotive vehicle comprises fitting a bolt in a bolt hole and turning the bolt, while pushing the bolt toward the bolt hole, by means of fingers or a screwdriver. It is to be noted that in such a very narrow place, for example, within an engine compartment of an automotive vehicle, it is often impossible to use a wrench because there is no space for turning a handle of the wrench forward and backward.

However, it is very difficult and inefficient to turn the bolt, while pushing the bolt toward the bolt hole, by means of fingers or a screwdriver.

### SUMMARY OF THE INVENTION

It is therefore an object of the invention to provide a tool for tightening a bolt, which has obviated the above-mentioned disadvantage of the prior art.

It is another object of the invention to provide a tool for tightening a bolt in a very narrow place easily and efficiently.

These and other objects have been attained by the following tools:

(1) A tool for tightening a blot comprising a substantially circular plate, said substantially circular plate having a thickness approximately the same as the thickness of a hexagonal bolt head, said substantially circular plate being provided in a center thereof with a socket, said socket having a hexagonal shape corresponding to said hexagonal bolt head, said socket having a stopper portion adapted to contact a top surface of said bolt head so as to prevent said bolt head from passing through said socket, said substantially circular plate being provided on a periphery thereof with engagement projections, said substantially circular plate being easily turned by pushing one of said engagement projections by means of a tip of a screwdriver.

(2) Said socket may have a dodecagonal shape corresponding to said hexagonal bolt head.

(3) A tool for tightening a blot comprising a substantially circular plate, said substantially circular plate having a thickness approximately the same as the thickness of a hexagonal bolt head, said substantially circular plate being provided in a center thereof with a first socket, said first socket having a dodecagonal shape corresponding to said hexagonal bolt head, said substantially circular plate being further provided at the back of said first socket with a hexagonal second socket, said second socket being formed continuously to said first socket so that each edge of said second socket lies on the extension line of an edge of said first socket, said second socket allowing said bolt head to enter said second socket from said first socket and to pass through said substantially circular plate, said substantially circular plate being provided on a periphery thereof with engagement projections, said substantially circular plate being easily turned by pushing one of said engagement projections by means of a tip of a screwdriver.

(4) Each of said substantially circular plate is preferably made of a magnet.

Now the operation of the tool for tightening a bolt according to the present invention will be described.

(1) Tool with a Hexagonal Socket

A bolt is tightened in a very narrow place by means of the above-mentioned tool with a hexagonal socket as follows:

The tool is attached to the bolt by fitting the hexagonal socket of the substantially circular plate to the bolt head. A threaded end of the bolt is fitted in a bolt hole. Then, the tool is turned by pushing one of the engagement projections by means of a tip of a screwdriver while the tool is pushed toward the bolt hole by a finger, etc. When the tool is pushed toward the bolt hole, the stopper portion of the socket pushes the bolt toward the bolt hole. When the tool is turned, the bolt is turned thereby because the hexagonal bolt head is fitted in the hexagonal socket of the tool. The tool is easily turned by pushing one of the engagement projections on the periphery of the substantially circular plate by means of a tip of a screwdriver.

(2) Tool with a Dodecagonal Socket

The tool with a dodecagonal socket is used in the same way as said tool with the hexagonal socket.

(3) Tool with a First Socket and a Second Socket

Six edges (reference symbol “a” in FIG. 8) among the twelve edges of a dodecagonal first socket lie on the extension lines of the six edges (reference symbol “a”) of the hexagonal second socket, while other six edges (reference symbol “b” in FIG. 8) of the dodecagonal first socket do not continue to the six edges (reference symbol “a”) of the hexagonal second socket. See FIG. 8. The angle between adjacent edges “a” and “b” of the dodecagonal first socket is 30 degree.

When the six edges of the bolt head coincide with said other six edges (reference symbol “b” in FIG. 8) of the dodecagonal first socket which do not continue to the six edges (reference symbol “a”) of the hexagonal second socket, then the bolt head is in contact with a step (reference symbol “c” in FIGS. 6 and 8) and is not allowed to enter the hexagonal second socket. This means that the step “c” has the same function as said stopper portion of the tool. At this time, the tool with the first socket and the second socket is used in the same way as the said tool with the hexagonal or dodecagonal socket. See FIG. 6.

When the six edges of the bolt head coincide with the six edges (reference symbol “a” in FIG. 8) of the dodecagonal first socket which lie on the extension lines of the six edges (reference symbol “a”) of the hexagonal second socket, that is, when the tool is turned 30 degrees from the position mentioned above, then the bolt head is allowed to move from the first socket to the second socket and further to pass through the substantially circular plate. Therefore, even if there is an obstacle (reference symbol 19 in FIG. 7) in a position in which the substantially circular plate is to be used, it is possible to avoid the obstacle by inserting the bolt head into the first socket and the second socket until the bolt head protrudes a little from the substantially circular plate and then turn the substantially circular plate by pushing one of the engagement projections by means of a tip of a screwdriver. See FIG. 7.

(4) Tool with a Substantially Circular Plate Made of a Magnet

The substantially circular plate made of a magnet attracts the bolt head. Therefore, the tool is very easy to use.

### BRIEF DESCRIPTION OF THE DRAWINGS

FIG. 1 is a sectional view showing a tool for tightening a bolt in use.

FIG. 2 is a plan view of said tool.

FIG. 3 is a sectional view of said tool.

FIG. 4 is a plan view of another tool for tightening a bolt.

FIG. 5 is a sectional view of said tool.

FIG. 6 is a sectional view showing a further tool for tightening a bolt in use.

FIG. 7 is another sectional view showing said tool in use.

FIG. 8 is a plan view of said tool.

FIG. 9 is a sectional view of said tool.

### DETAILED DESCRIPTION OF THE INVENTION

The present invention will now be described in detail with reference to the attached drawings.

Reference symbol 1 represents a substantially circular plate. The substantially circular plate 1 has a thickness 1a approximately the same as the thickness 3a of a hexagonal bolt head 3. For example, The substantially circular plate 1 has a thickness 1a of about 5 to 10 mm. The substantially circular plate 1 is provided in a center thereof with a socket 5. The socket 5 has a hexagonal shape corresponding to the hexagonal bolt head 3. The socket 5 has a stopper portion 7 adapted to contact a top surface 3b of the bolt head 3 so as to prevent the bolt head 3 from passing through the socket 5. The stopper portion 7 is provided in a center thereof with an opening 11. The substantially circular plate 1 is provided on a periphery thereof with engagement projections 9. The substantially circular plate 1 is easily turned by pushing one of the engagement projections 9 by means of a tip of a screwdriver 23.

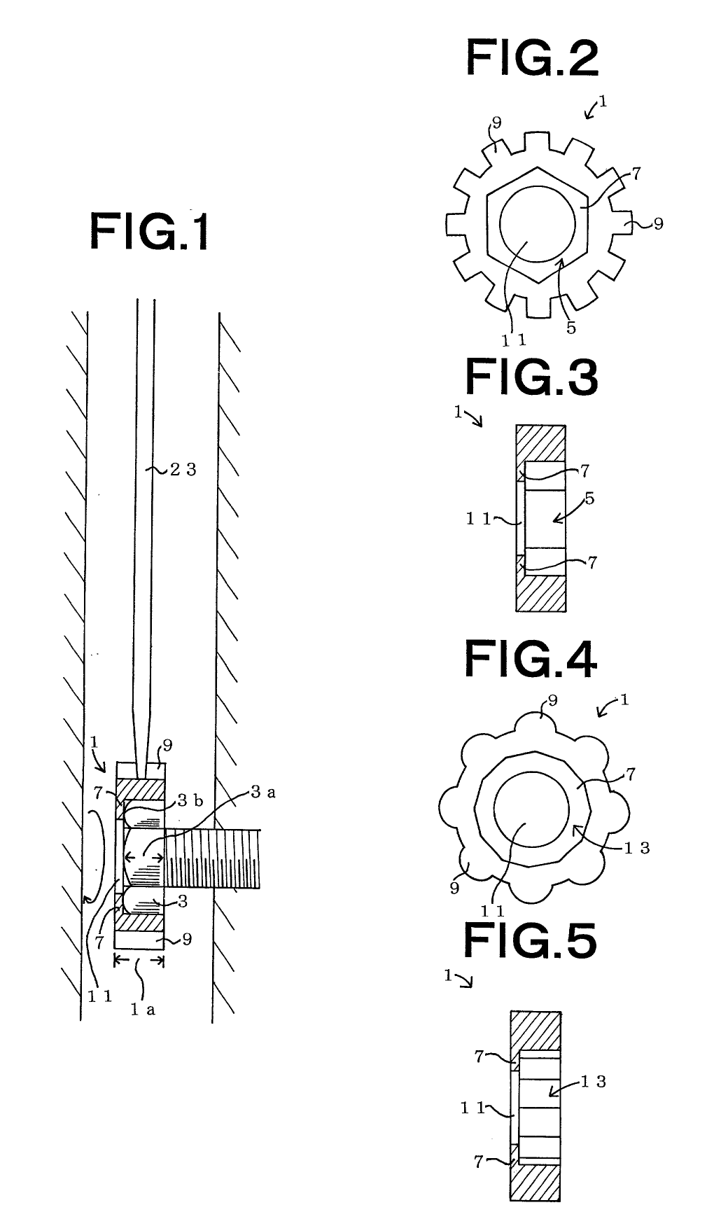

The engagement projections 9 on the periphery of the substantially circular plate 1 may be anything as long as the substantially circular plate 1 attached to the bolt head 3 can be easily turned by pushing one of the engagement projections 9 by means of a tip of a screwdriver 23. The number of the engagement projections 9 is optional. In embodiments shown in FIGS. 1 to 3 and FIGS. 6 to 9, the engagement projections 9 have a substantially rectangular section. In an embodiment shown in FIGS. 4 and 5, the engagement projections 9 have a substantially semicircular section.

In an embodiment shown in FIGS. 4 and 5, the substantially circular plate 1 is provided in a center thereof with a socket 13, which has a dodecagonal shape corresponding to the hexagonal bolt head 3. In other respects, this embodiment is the same as the above-mentioned embodiment shown in FIGS. 1 to 3.

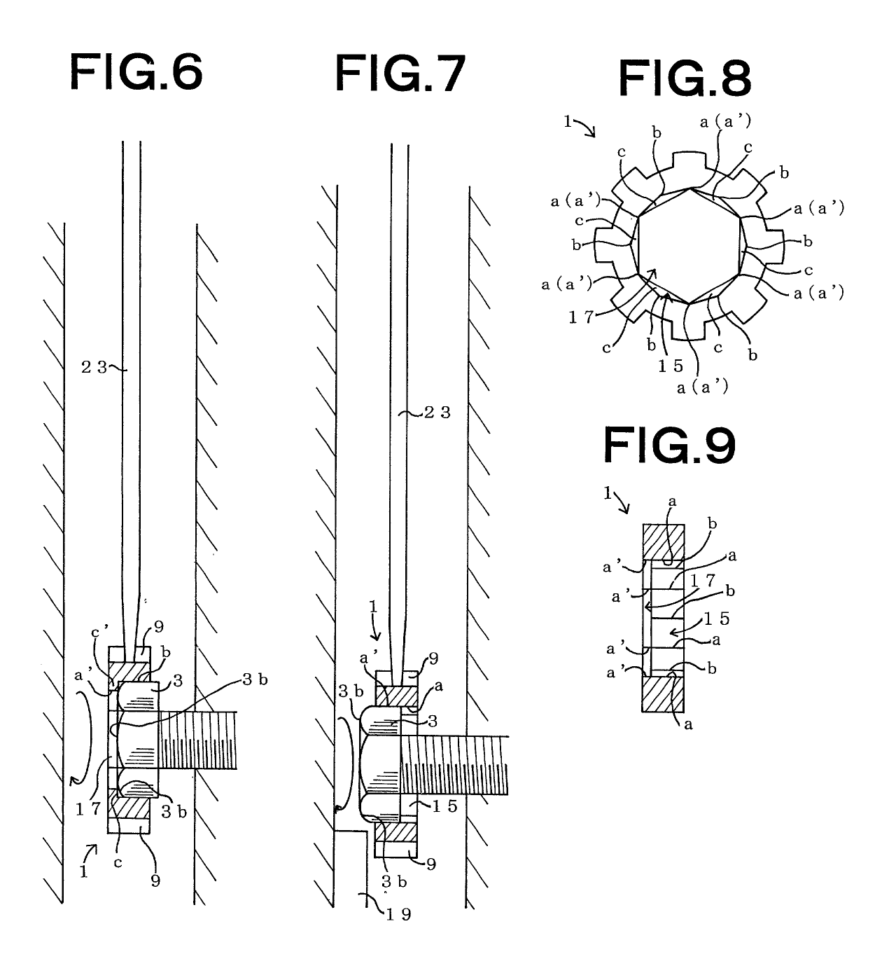

The embodiment shown in FIGS. 6 to 9 will now be described. The substantially circular plate 1 having a thickness 1a approximately the same as the thickness 3a of the hexagonal bolt head 3 is provided in a center thereof with a first socket 15. The first socket 15 has a dodecagonal shape corresponding to the hexagonal bolt head 3. The substantially circular plate 1 is further provided at the back of the first socket 15 with a hexagonal second socket 17. The second socket 17 is formed continuously to the first socket 15 so that each edge “a” of the second socket 17 lies on the extension line of an edge “a” of the first socket 15. The second socket 17 allows the bolt head 3 to enter the second socket 17 from the first socket 15 and to pass through the second socket 17 i.e. the substantially circular plate 1. The second socket 17 does not have a stopper portion mentioned above. The substantially circular plate 1 is provided on a periphery thereof with engagement projections 9. The substantially circular plate 1 is easily turned by pushing one of the engagement projections 9 by means of a tip of a screwdriver 23.

The substantially circular plate 1 is preferably made of a magnet.

The present invention has the following advantages:

(1) Tool with a Hexagonal Socket

The tool of the present invention does not have a handle which has to be turned forward and backward. The substantially circular plate has a thickness approximately the same as the thickness of a hexagonal bolt head. This means that the substantially circular plate is very thin. Therefore, even in a very narrow place in which a wrench cannot be used because there is no space for turning a handle of a wrench forward and backward, the tool of the present invention makes it possible to tighten the bolt easily and efficiently.

(2) Tool with a Dodecagonal Socket

The tool with a dodecagonal socket has the same advantages as said tool with the hexagonal socket.

(3) Tool with a First Socket and a Second Socket

Even if there is an obstacle in a position in which the substantially circular plate is to be used, it is possible to avoid the obstacle by inserting the bolt head into the first socket and the second socket until the bolt head protrudes a little from the substantially circular plate and then turn the substantially circular plate by pushing one of the engagement projections by means of a tip of a screwdriver.

(4) Tool with a Substantially Circular Plate Made of a Magnet

The substantially circular plate made of a magnet attracts the bolt head. Therefore, the tool is very easy to use.

As many apparently widely different embodiments of the present invention may be made without departing from the spirit and scope thereof, it is to be understood that the invention is not limited to the specific embodiments thereof except as defined in the appended claims.

1. A tool for tightening a blot comprising a substantially circular plate, said substantially circular plate having a thickness approximately the same as the thickness of a hexagonal bolt head, said substantially circular plate being provided in a center thereof with a socket, said socket having a hexagonal shape corresponding to said hexagonal bolt head, said socket having a stopper portion adapted to contact a top surface of said bolt head so as to prevent said bolt head from passing through said socket, said substantially circular plate being provided on a periphery thereof with engagement projections, said substantially circular plate being easily turned by pushing one of said engagement projections by means of a tip of a screwdriver.

2. A tool as claimed in claim 1, wherein said substantially circular plate is made of a magnet.

3. A tool for tightening a blot comprising a substantially circular plate, said substantially circular plate having a thickness approximately the same as the thickness of a hexagonal bolt head, said substantially circular plate being provided in a center thereof with a socket, said socket having a dodecagonal shape corresponding to said hexagonal bolt head, said socket having a stopper portion adapted to contact a top surface of said bolt head so as to prevent said bolt head from passing through said socket, said substantially circular plate being provided on a periphery thereof with engagement projections, said substantially circular plate being easily turned by pushing one of said engagement projections by means of a tip of a screwdriver.

4. A tool as claimed in claim 3, wherein said substantially circular plate is made of a magnet.

5. A tool for tightening a blot comprising a substantially circular plate, said substantially circular plate having a thickness approximately the same as the thickness of a hexagonal bolt head, said substantially circular plate being provided in a center thereof with a first socket, said first socket having a dodecagonal shape corresponding to said hexagonal bolt head, said substantially circular plate being further provided at the back of said first socket with a hexagonal second socket, said second socket being formed continuously to said first socket so that each edge of said second socket lies on the extension line of an edge of said first socket, said second socket allowing said bolt head to enter said second socket from said first socket and to pass through said substantially circular plate, said substantially circular plate being provided on a periphery thereof with engagement projections, said substantially circular plate being easily turned by pushing one of said engagement projections by means of a tip of a screwdriver.

6. A tool as claimed in claim 5, wherein said substantially circular plate is made of a magnet.
